(19) United States
(12) Patent Application Publication
(10) Pub. No.: US 2004/0111329 A1
(43) Pub. Date: Jun. 10, 2004

(54) Restricted-use transaction systems

(75) Inventor: Raymond Moore, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 10/316,977

(22) Filed: Dec. 10, 2002

(51) Int. Cl. G06F 17/60

(52) U.S. Cl. 705/26

(57) ABSTRACT

A method and system are provided for authorizing commercial transactions subject to certain transaction criteria. A purchaser of goods and/or services presents a transaction instrument at the time of a transaction. Transaction criteria that have been defined by a third party and that are associated with the transaction instrument are accessed. A determination is then made whether the transaction request is consistent with the transaction criteria.

### BACKGROUND OF THE INVENTION

This application relates generally to transaction systems, and relates more specifically to transaction systems that provide transaction instruments whose use may be restricted by a third party.

There are a variety of circumstances under which individuals wish to provide funds to others for specific purposes but it is often difficult for them to ensure that the funds are used for those purposes after they have been received. For example, when a child leaves home to attend college or university, a parent often wishes to provide support for the child. This is sometimes done by providing the child with a debit card or by cosigning for a credit card. Once the child is away from home, however, the child may be exposed to new influences and may use the card to make purchases that the parent does not wish to support, such as purchasing alcohol or tobacco. In the past, efforts to ensure that the funds provided to the child are used for their intended purpose has been performed through the use of stored-value cards that are provided periodically, such as weekly. By providing only sufficient funds for the child's needs each week, instead of giving unrestricted access to greater funds, the expectation is that necessity will cause the child to limit purchases to conform with the intentions of the parent. In many instances, such an approach is unsuccessful because there is still no restriction on the use of the funds once they are in the hands of the child.

A similar situation exists with respect to charitable donations. This is true particularly for out-of-pocket donations where donors fear that the donations may be used for the purchase of alcohol instead of for the purchase of food. Such reservations cause otherwise willing individuals to withhold their donations. This is true even in instances with more organized charities. The existence of highly publicized cases in which donations to an organized charity were redirected so that the expected recipients did not receive all or even part of the funds causes many to curtail their donations. Charities would generally receive greater contributions if the donors were confident that the funds would only be used as intended.

One technique that has been used to attempt to restrict donations occurs most often in connection with government programs to provide food or medicine. For example, government-issued coupons such as Medicare coupons or food stamps are issued with specific restrictions on the types of goods they may be used to purchase. However, these restrictions are only as effective as the level of compliance with them by individual clerks completing transactions. Often, the restrictions are circumvented when a clerk allows the government-issued coupons to be used to purchase non-approved goods, and in some instances clerks have been known to provide cash as change. The effect of such circumvention, particularly if widespread or publicized, results in frustration of the program under which the coupons are issued, often leading to criticism of the program as a failure solely on the basis of its implementation. If the public could be assured that the funds being provided under such programs were being used only as intended, debate about the effectiveness of the program could focus on its own merits and weaknesses rather than on peripheral issues such as flaws in its implementation.

Each of these examples points to a general need in the art for methods and systems by which funds may be provided to others without losing control over how those funds are to be used.

### BRIEF SUMMARY OF THE INVENTION

Embodiments of the invention thus provide a method and system for authorizing commercial transactions subject to certain transaction criteria. A purchaser of goods and/or services presents a transaction instrument at the time of a transaction, but conditions may have been defined by a third party with respect to the permitted characteristics of the transaction. For example, the purchaser might be a child of the third party or might be the recipient of a charitable donation from the third party. Before the transaction is executed a comparison is made between the previously specified transaction criteria and the characteristics of the transaction. The transaction may be denied, in whole or in part, if the transaction criteria are not met.

Thus, in a first embodiment, a transaction request that identifies a transaction instrument is received by an authorization system. Transaction criteria that have been defined by a customer and that are associated with the transaction instrument are accessed. A determination is then made whether the transaction request is consistent with the transaction criteria. The transaction criteria may provide one or more types of limits on approval of the transaction request, including a temporal limit, a geographical limit, a limit on a transaction party, and a limit on a transaction subject. The transaction instrument may be selected from the group consisting of a credit card, a debit card, a chip card, a prepaid card, a coupon, and a government-issued coupon.

The methods of the present invention may be embodied in a computer-readable storage medium having a computer-readable program embodied therein for directing operation of a computer system. Such a computer system may include a processor and a storage device. The computer-readable program includes instructions for operating the computer system to authorize a commercial transaction in accordance with the embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a schematic diagram providing an overview of a system in accordance with an embodiment of the invention;

FIG. 2 provides a schematic overview of a computer system on which methods of the invention may be embodied;

FIG. 3 is a flow diagram that illustrates execution of a commercial transaction in accordance with an embodiment of the invention;

FIG. 4 is a sample screen shot of a web page showing existing transaction criteria and permitting changing the transaction criteria; and

FIG. 5 is a flow diagram that illustrates changing transaction criteria in accordance with an embodiment of the invention.

### DETAILED DESCRIPTION OF THE INVENTION

Embodiments of the invention permit commercial transactions to be executed with transaction instruments whose use has been restricted. Usually the restrictions have been established by a person who is not actually a party to the commercial transactions executed with the transaction instruments. As used herein, the term “transaction instruments” is intended to refer to physical instruments that may be used for the purchase of goods and/or services. In some instances, only an authorized person may use the transaction instrument, such as when funds for the transaction are provided on a credit or debit basis. In other instances, any bearer of the transaction instrument may use it to enter a transaction, such as when the funds are provided on a prepaid basis. Examples of transaction instruments include credit cards, debit cards, prepaid cards, gift cards, chip cards (“smart” cards), coupons, and government-issued coupons.

In the field of commercial transactions, it is often believed that greater flexibility can be achieved if there is no tie to a physical transaction instrument. Despite this pervasive belief, the inventor has recognized that for embodiments of the invention, flexibility is actually enhanced by associating commercial transactions with physical transaction instruments. Such an association does not preclude execution of commercial transactions remotely, such as by telephone or over the Internet, in which an identification of the transaction instrument is provided by the purchaser to the merchant. However, the existence of the transaction instrument greatly increases the number and scope of commercial transactions that may be executed, particularly for in-person transactions where presentment of either cash or a transaction instrument is almost universally expected. If the commercial transactions were not associated with a physical instrument, their scope would be significantly restricted and consist, for example, of only online Internet-based transactions.

Generally, a record setting forth transaction criteria associated with each transaction instrument is stored so as to be electronically accessible by an authorization system. As used herein, transaction criteria are distinct from administrative criteria that govern the use of a transaction instrument, such as whether a transaction will cause a balance to exceed a balance limit. Instead, transaction criteria are directed to characteristics of the transaction itself. When a purchaser of goods and/or services presents or identifies the transaction instrument for execution of a transaction, the authorization system checks the associated transaction criteria to determine whether the transaction is consistent with the criteria. If the purchaser is attempting to purchase goods and/or services inconsistent with the transaction criteria, the entire transaction or only the portion inconsistent with the transaction criteria may be denied.

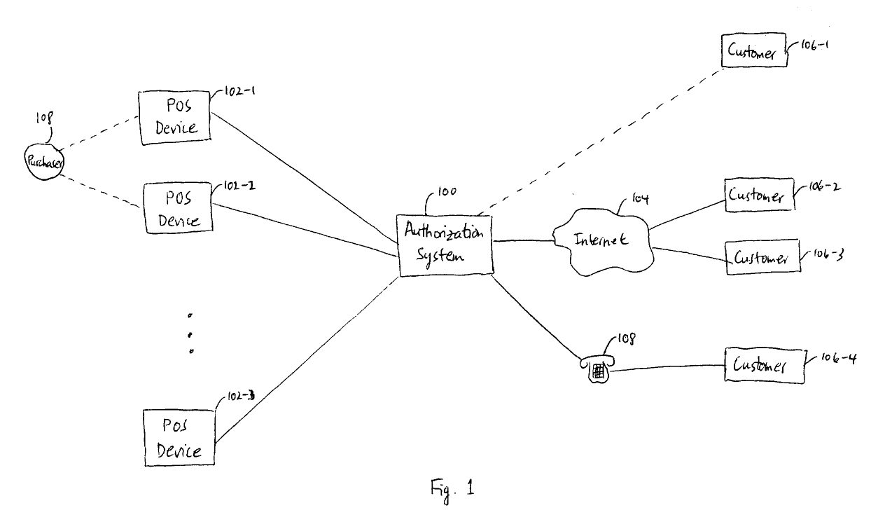

An overview of how the authorization system may be integrated into an existing financial infrastructure for executing transactions is shown for one embodiment in FIG. 1. In this embodiment, the authorization system 100 is in communication with a plurality of point-of-sale devices 102 equipped to transmit information regarding transactions from a point of sale to the authorization system 100. While it is possible that information regarding the transaction may be input into the point-of-sale device 102 by hand by a clerk, it is generally expected that the point-of-sale device 102 will be configured so that this is done automatically. For example, in some embodiments, the point-of-sale device 102 is connected with a bar-code scanner of the type known in the art. In addition to using the bar-code information on products to determine a total price for the transaction, information regarding the type of goods and/or services is also identified for transmission through the point-of-sale device 102 to the authorization system. In other embodiments, the point-of-sale device 102 is connected with a computer system from which goods and/or services being purchased are identified by the clerk, with information regarding the type of goods and/or services similarly being identified by the computer system for transmission through the point-of-sale device 102 to the authorization system. Still other techniques for allowing the point-of-sale device 102 to obtain and transmit information regarding the types of goods and/or services to the authorization system 100 will be known to those of skill in the art.

In addition to transmitting price and goods/services information, the point-of-sale device is equipped to transmit information regarding the transaction instrument being used. In some embodiments, this is done by reading a magnetic stripe on the transaction instrument as is commonly done for credit and debit cards. In embodiments where the transaction instrument comprises a chip card, the point-of-sale device 102 may be equipped with a chip-card reader that extracts an identification of the transaction instrument. In embodiments where the transaction instrument comprises a coupon or a government-issued coupon, a bar code may identify the transaction instrument and be read by a bar-code reader comprised by the point-of-sale device 102. In still other embodiments, other devices suitable for identifying the transaction instrument may be comprised by the point-of-sale device 102, including optical readers and magnetic-ink readers, among others. Examples of point-of-sale devices that include multiple capabilities for identifying transaction instruments are provided in the following commonly assigned applications, the entire disclosures of which are incorporated herein by reference for all purposes: U.S. Prov. Pat. Appl. No. 60/147,889, entitled “INTEGRATED POINT OF SALE DEVICE,” filed Aug. 9, 1999 by Randy J. Templeton et al.; U.S. patent application Ser. No. 09/634,901, entitled “POINT OF SALE PAYMENT SYSTEM,” filed Aug. 9, 2000 by Randy J. Templeton et al.; U.S. patent application Ser. No. 10/116,689, entitled “SYSTEMS AND METHODS FOR PERFORMING TRANSACTIONS AT A POINT-OF-SALE,” filed Apr. 3, 2002 by Eamey Stoutenburg et al.; U.S. patent application Ser. No. 10/116,733, entitled “SYSTEMS AND METHODS FOR DEPLOYING A POINT-OF-SALE SYSTEM,” filed Apr. 3, 2002 by Earney Stoutenburg et al.; U.S. patent application Ser. No. 10/116,686, entitled “SYSTEMS AND METHODS FOR UTILIZING A POINT-OF-SALE SYSTEM,” filed Apr. 3, 2002 by Earney Stoutenburg et al.; and U.S. patent application Ser. No. 10/116,735, entitled “SYSTEMS AND METHODS FOR CONFIGURING A POINT-OF-SALE SYSTEM,” filed Apr. 3, 2002 by Earney Stoutenburg.

The point-of-sale devices 102 thus act to provide an interface between a purchaser 108 wishing to execute a transaction and the authorization system 100 at the time of the transaction. Interfaces may also be provided between the authorization system 100 and customers 106 who control the transaction criteria that limit transactions. As used herein, “purchaser” refers to one who wishes to execute a transaction for goods or services using a transaction instrument and “customer” refers to a client of the authorization system who specifies criteria used in authorizing purchases. While it is possible in some embodiments for the purchaser also to be a customer, it is expected more usually that the purchaser and customer are different individuals. The interface is intended to permit a customer 106 to monitor and modify the transaction criteria as desired and to review transactions that may have been executed with the transaction instrument. In one embodiment, the interface between the customers 106 and authorization system 100 is provided with the Internet 104. In FIG. 1, such an interface is indicated for customers 106-2 and 106-3. An Internet interface permits customers 106 to access and modify transaction criteria, and also to view executed transaction information, conveniently with a browser. In another embodiment, the interface between the customers 106 and authorization system 100 is provided with a telephone system 108. In FIG. 1, such an interface is indicated for customer 106-4. A telephone-system interface permits customers 106 to access and modify transaction criteria, and also to be presented with a summary of executed transaction information over any telephone; usually, access and modification of such information is accomplished by using dual-tone multiple-frequency (“DTMF”) commands from a touch-tone telephone. FIG. 1 also notes that in still other embodiments, the customer may interact directly with the authorization system 100, such as by physically visiting the offices of an administrator of the authorization system 100. This embodiment is noted schematically for customer 106-1.

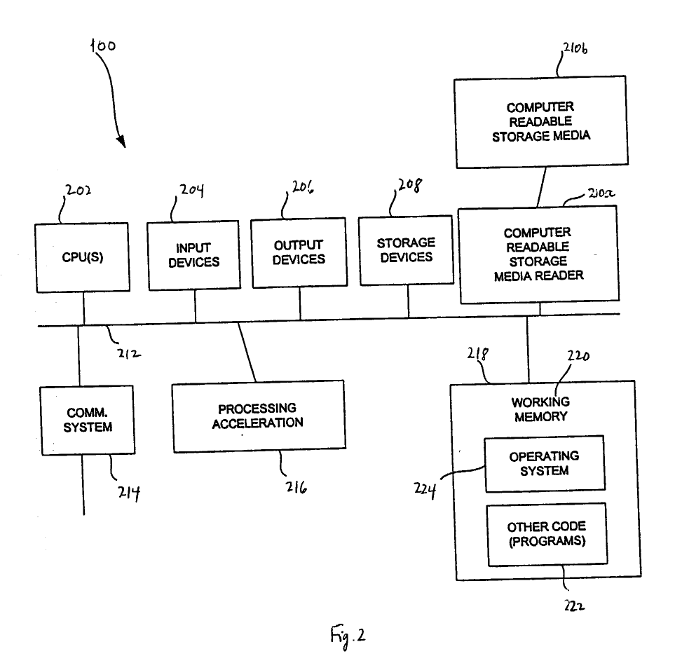

A structure for the authorization system in one embodiment is shown schematically in FIG. 2, in which methods of the invention are implemented on a computer system. This figure broadly illustrates how individual system elements may be implemented in a separated or more integrated manner. The authorization system 100 is shown comprised of hardware elements that are electrically coupled via bus 212, including a processor 202, an input device 204, an output device 206, a storage device 208, a computer-readable storage media reader 210a, a communications system 214, a processing acceleration unit 216 such as a DSP or special-purpose processor, and a memory 218. The computer-readable storage media reader 210a is further connected to a computer-readable storage medium 210b, the combination comprehensively representing remote, local, fixed, and/or removable storage devices plus storage media for temporarily and/or more permanently containing computer-readable information. The communications system 214 may comprise a wired, wireless, modem, and/or other type of interfacing connection and permits data to be exchanged with the authorization system 100, such as with a point-of-sale device 102 or customer interface.

The authorization system 100 also comprises software elements, shown as being currently located within working memory 220, including an operating system 224 and other code 222, such as a program designed to implement methods of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

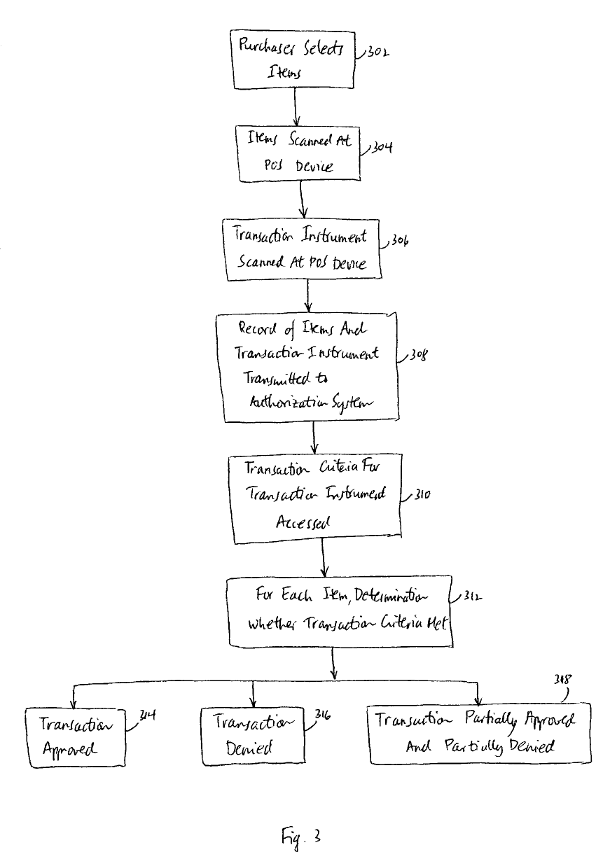

The flow diagram of FIG. 3 illustrates how authorization of a transaction may proceed in an embodiment. At block 302, a purchaser selects one or more items to be purchased using the transaction instrument. The items may include goods and/or services. They are identified at the point-of-sale device 102 at block 304 using any suitable capability of the point-of-sale device 102. In one embodiment, a bar code is read from the item, such as from an affixed label when the item is a good or from a certificate when the item is a service. The identification by the point-of-sale device 102 is generally sufficient to identify both the price of each item as well as to provide a classification of each item. In embodiments that use bar codes, for example, classification may be deduced from the bar code in accordance with standardized classification systems, including, for example, the Universal Product Code (“UPC”) system, the European Article Number (“EAN”) system, the Global Trade Item Number (“GTIN”) system, the Serialized Shipping Container Code (“SSCC”) system, the Global Location Number (“GLN”) system, the Global Returnable Asset Identifier (“GRAI”) system, the Global Individual Asset Identifier (“GIAI”) system, and the Global Service Relation Number (“GSRN”) system, among others. Many of these systems are currently administered by the Uniform Code Council, Inc. (“UCC”) and EAN International. While the emphasis of the these organizations is currently on bar-code technologies, including Reduced Space Symbology (“RSS”) and Composite Symbology (“CS”), they acknowledge that the systems may alternatively be implemented using other technologies, such as with radiofrequency tags. Embodiments of the invention are not restricted to any particular classification technology and are intended to encompass all such classification systems.

In addition to identifying the items to be purchased at the point of sale, an identification is made of the transaction instrument at block 306 using any suitable technique supported at the point of sale, including magnetic-stripe identification, optical identification, and chip-card identification. The identifications of both the items to be purchased and the transaction instrument are forwarded to the authorization system 100 at block 308. The authorization system 100 then accesses the transaction criteria associated with the identified transaction instrument from the storage device 208 at block 310, permitting a comparison to be made whether the classification of the identified items conforms with the transaction criteria. In one embodiment, such a comparison is performed on an item by item basis. The figure notes three possible results of such a comparison. If all the items conform to the transaction criteria, the entire transaction may be approved at block 314, and a corresponding notification transmitted back to the point-of-sale device 102. If any of the items fails to conform to the transaction criteria, the entire transaction may be denied at block 316, and a corresponding notification transmitted back to the point-of-sale device 102. In addition, block 318 notes an embodiment in which the transaction is partially approved and partially denied because some of the items conform to the transaction criteria and some do not. Notification of the partial approval is subsequently transmitted back to the point-of-sale device 102. If all or part of the transaction is approved, transaction information is routed by the authorization system to execute the transaction. This may comprise, for example, notifying a credit-card company, debiting a bank account, or changing a prepaid value of a stored-value card.

The comparisons made at blocks 312 in the illustration of FIG. 3 focus on classifications of the items to be purchased, but other criteria may additionally or alternatively be used in other embodiments. For example, in one embodiment, the transaction criteria include temporal limit, such as a limit on the time of day at which purchases may be made. In such an embodiment, the information transmitted to the authorization system at block 308 includes an identification of the time of day. The determination whether to approve or deny the transaction thus includes comparing whether the transmitted time identification is consistent with any such limitation provided in the transaction criteria. This time information may also be used for other temporal limits, such as where the transaction criteria limit the number of times transactions may be approved within a given time period. In another embodiment, the transaction criteria may include a limit on geographical location where purchases may be made. Such a location limitation may be included in the transaction criteria in terms of a postal code, telephone area code, census block group, county identification, or other geographical identifier. In such an embodiment, the information transmitted to the authorization system at block 308 thus includes an identification of the geographical location where the transaction request is made, using the same type of identifier. The determination whether to approve or deny the transaction in such an embodiment thus includes comparing whether the transmitted location information is consistent with any such limitation provided in the transaction criteria. In some instances, such geographical restrictions are used to limit the potential for fraudulent use of the transaction instrument, such as if it is stolen; this fraud-mitigation ability is used in a specific embodiment in which the customer and purchaser are a single individual who identifies a limited geographical scope for transactions. In still another embodiment, the transaction criteria include a limitation on the merchant from which purchases may be made. Such a limitation may be recorded in the transaction criteria on a merchant-by-merchant basis or may be recorded in terms of the type of merchant. The limitation is effected by transmitting an identification of the merchant at block 308 so that the determination whether to approve the transaction includes comparing that identification with the transaction criteria.

For each of these different types of comparisons, the transaction criteria may be specified either positively or negatively. A positive specification specifies the classification(s) of items that may be purchased, the time(s) of day at which transactions may be executed, the geographical location(s) at which transactions may be executed and/or the merchant(s) at which transactions may be executed. Where criteria are specified positively, any transaction criteria that are not specified are considered to be prohibited. A negative specification instead specifies the classification(s) of items that may not be purchased, the time(s) of day at which transactions may not be executed, the geographical location(s) at which transactions may not be executed and/or the merchant(s) at which transactions may not be executed. Where criteria are specified negatively, any transaction criteria that are not specified are considered to be permitted. In some instances, a mixture of positive and negative specifications may be used. For example, in one embodiment a parent may specify transaction criteria for a child that uses a negative specification to prohibit purchases of alcohol and tobacco but uses a positive specification to ensure transactions are only executed near a university being attended by the child.

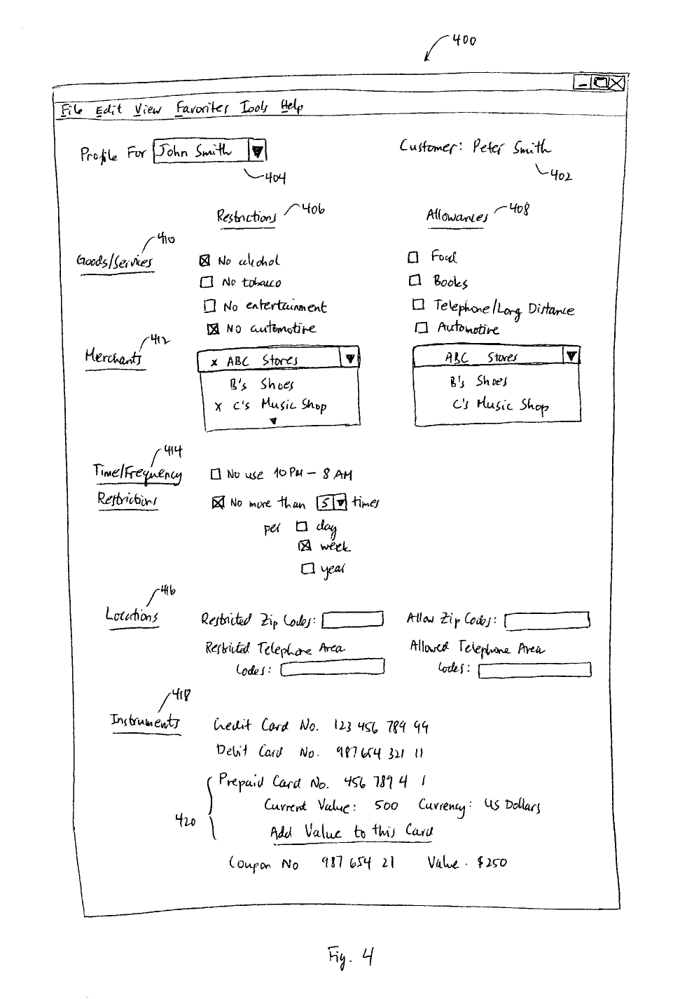

Some of the different types of transaction criteria that may be used are summarized in the sample screen shot shown in FIG. 4. This figure shows an example of a screen 400 that may be presented to a customer to review, select, or update transaction criteria as part of an interface with the authorization system. Generally, this screen will be reached after the customer enters confidential identification information, such as in the form of a password. The screen 400 identifies the customer name 402 for the customer who has control over the transaction criteria and identifies the authorized purchaser(s) in field 404. The illustration in FIG. 4 also shows that field 404 may accommodate multiple purchasers with different transaction criteria, and which may be accessed with a drop-down menu. Such a capability is suitable when a customer wishes to control transaction criteria for multiple purchasers, such as when the customer is a parent supporting multiple children attending university. Whenever a switch is made to a different purchaser, the screen 400 is updated with transaction criteria for that purchaser. If no transaction criteria have previously been specified, the screen 400 is displayed without the transaction criteria completed. As discussed in greater detail below, each purchaser may also be associated with multiple transaction instruments in some embodiments.

The screen may be divided into sections that correspond to the different types of transaction criteria, identified in the example as limiting the types of goods and/or services in field 410, limiting the merchants with whom transactions may be executed in field 412, limiting the time and/or frequency of transactions in field 414, and limiting the geographical location of transactions in field 416. Each of these fields may similarly be divided into sections that correspond to negative limitations (labeled “Restrictions” 406) and to positive limitations (labeled “Allowances” 408) on the transactions. Generally, the restrictions may be entered using a variety of formats, including check boxes (such as in fields 410 and 414), drop-down menus (such as in fields 412 and 414) and free-form inputs (such as in fields 416).

Thus, in the example of FIG. 4, customer Peter Smith has established a profile for purchaser John Smith. In this profile, John Smith is restricted from using any of the transaction instruments listed in field 418 for the purchase of alcohol or automotive products as set forth in field 410. In addition, John Smith is not permitted to execute transactions at ABC Stores or at C's Music Shop, as set forth in field 412. According to field 414, no restrictions have been placed on the time of day the transaction instruments may be used, although they may not be used more than five times a week. Although no geographical-location restrictions have been imposed in field 416, it would be possible for Peter Smith to enter such restrictions by specifying the ZIP codes or telephone area codes where John is either permitted to or prohibited from executing transactions.

Field 418 specifies the specific instruments to which the transaction criteria apply. In this example, four different types of instruments have been identified, including a credit card, a debit card, a prepaid card, and a coupon. A coupon may generally be used only once while a prepaid card may be used multiple times, with the balance on the card being reduced after each transaction. A coupon is thus generally considered to be an example of a disposable instrument. In some instances, a prepaid card may also be used as a disposable instrument so that it is discarded after the prepaid amount has been depleted; such instruments are especially suitable for use in embodiments of the invention in connection with charitable contributions. In other instances, it may be possible to replenish value on the prepaid card. Such a possibility is indicated in field 420 of FIG. 4, where the current value stored on the prepaid card is noted and a link is provided to add value to the card. Value may be added by charging an account of the customer's. In this way, the customer may exert discretionary control over the amount spent by the purchaser with the transaction instrument(s), in addition to specifying characteristics of the individual transactions.

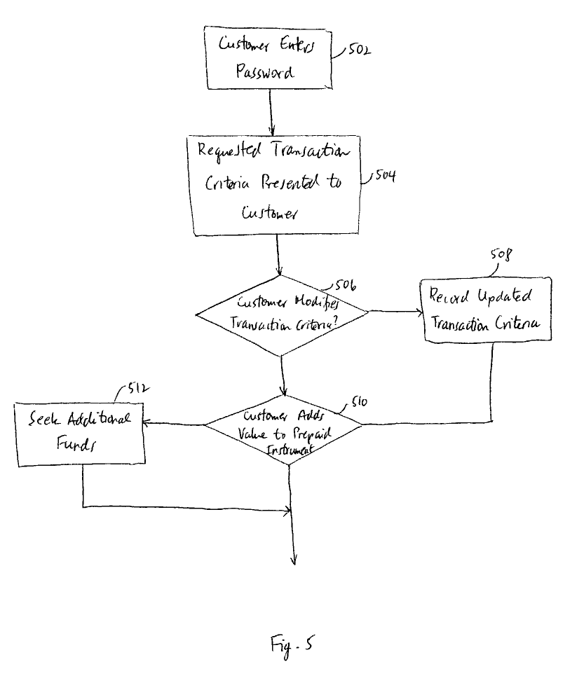

Thus, FIG. 5 provides a flow diagram that summarizes the how the interface with the authorization system may be used to monitor or update transaction criteria. At block 502, the interface is accessed by entering a password. Upon verification of the password as identifying the customer, the transaction criteria are presented at block 504, such as in the form shown in FIG. 4. A check is made at block 506 to determine whether the customer modifies any of the transaction criteria; if so, the updated transaction criteria are recorded at block 508. At block 510, a check is made whether the customer seeks to add value to any of the applicable prepaid instruments; if so, additional funds to be applied to that instrument are sought at block 512.

The example used in connection with FIGS. 4 and 5 focuses on a situation in which the customer is an individual, but it will be clear to those of skill in the art that the system may readily be extended to situations in which the customer is a larger entity. For example, in instances where a government program is operated by issuing coupons to individuals for the purchase of specific goods, embodiments of the invention may be used to ensure use of the government-issued coupons is restricted. It will generally not be desirable to tailor the restrictions applicable to each government-issued coupon, in part because the relationship between the customer and purchaser is not as close and in part because of the volume of government-issued coupons. The interface with the authorization system does, however, facilitate making global changes to the way in which the government-issued coupons may be used. Such global changes provide a simple way of implementing policy or administration changes in the corresponding government program. In still other embodiments, the customer may be a business that issues coupons, for which similar efficiencies result from the same ability to effect global changes in the use of those coupons.

It will be appreciated that the screen shown in FIG. 4 is merely one of a series of screens that may be used to manage transaction criteria in accordance with embodiments of the invention. For example, another function that may be provided to customers, and shown on an applicable screen, is the ability to monitor and review transactions that have been executed by the associated purchaser(s). Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for authorizing a commercial transaction, the method comprising:
receiving a transaction request, wherein the transaction request identifies a transaction instrument and one or more items;
accessing transaction criteria associated with the transaction instrument, wherein the transaction criteria have been defined by a customer; and
determining, for each item, whether the transaction request is consistent with the transaction criteria.

2. The method recited in claim 1 further comprising approving a first portion of the transaction request and denying a second portion of the transaction request.

3. The method recited in claim 1 wherein the transaction criteria provide a temporal limit on when the transaction request may be approved.

4. The method recited in claim 1 wherein the transaction criteria provide a geographical limit on where the transaction request may be approved.

5. The method recited in claim 1 wherein the transaction criteria provide a limit on a transaction party identified in the transaction request that may be approved.

6. The method recited in claim 1 wherein the transaction criteria provide a limit on a transaction subject identified in the transaction request that may be approved.

7. The method recited in claim 1 wherein the transaction instrument is selected from the group consisting of a credit card, a debit card, a chip card, a prepaid card, a coupon, and a government-issued coupon.

8. The method recited in claim 1 wherein the transaction instrument is disposable.

9. A method for managing a commercial-transaction system, the method comprising:
maintaining records for a plurality of transaction instruments, wherein the records comprise transaction criteria defined by a customer and are associated with each of such transaction instruments;
receiving instructions for changing the transaction criteria associated with one of the transaction instruments; and
modifying the records to reflect the changed transaction criteria.

10. The method recited in claim 9 wherein the records further comprise an identification of a prepaid limit for at least one of the transaction instruments.

11. The method recited in claim 10 wherein the at least one of the transaction instruments is disposable.

12. The method recited in claim 10 wherein the prepaid limit is established by a cumulative value of contributions from a plurality of customers.

13. The method recited in claim 9 wherein receiving instructions for changing the transaction criteria comprises receiving instructions through an Internet interface.

14. The method recited in claim 9 wherein the transaction criteria provide a temporal limit on when transaction requests may be approved.

15. The method recited in claim 9 wherein the transaction criteria provide a geographical limit on where transaction requests may be approved.

16. The method recited in claim 9 wherein the transaction criteria provide a limit on transaction parties in transaction requests that may be approved.

17. The method recited in claim 9 wherein the transaction criteria provide a limit on transaction subjects in transaction requests that may be approved.

18. A computer-readable storage medium having a computer-readable program embodied therein for directing operation of a computer system including a communications system, a processor, and a storage device, wherein the computer-readable program includes instructions for operating the computer system to authorize a commercial transaction in accordance with the following:
receiving a transaction request with the communications system, wherein the transaction request identifies a transaction instrument;
accessing transaction criteria stored on the storage device, wherein the transaction criteria are associated with the transaction instrument and have been defined by a customer; and
determining with the processor whether the transaction request is consistent with the transaction criteria.

19. The computer-readable storage medium recited in claim 18 wherein the computer-readable program further includes instructions for approving a first portion of the transaction request and denying a second portion of the transaction request.

20. The computer-readable storage medium recited in claim 18 wherein the transaction criteria provide a limit on whether the transaction request may be approved, the limit being selected from the group consisting of a temporal limit, a geographical limit, a limit on a transaction party, and a limit on a transaction subject.

21. The computer-readable storage medium recited in claim 18 wherein the transaction instrument is selected from the group consisting of a credit card, a debit card, a chip card, a prepaid card, a coupon, and a government-issued coupon.

22. A computer-readable storage medium having a computer-readable program embodied therein for directing operation of a computer system including a communications system, a processor, and a storage device, wherein the computer-readable program includes instructions for operating the computer system to authorize a commercial transaction in accordance with the following:
maintaining records for a plurality of transaction instruments on the storage device, wherein the records comprise transaction criteria defined by a customer and are associated with each of such transaction instruments;
receiving instructions with the communications system for changing the transaction criteria associated with one of the transaction instruments; and
modifying the records with the processor to reflect the changed transaction criteria.

23. The computer-readable storage medium recited in claim 22 wherein the records further comprise an identification of a prepaid limit for at least one of the transaction instruments.

24. The computer-readable storage medium recited in claim 23 wherein the prepaid limit is established by a cumulative value of contributions from a plurality of customers.

25. The computer-readable storage medium recited in claim 22 wherein the transaction criteria provide a limit on approval of transaction requests, the limit being selected from the group consisting of a temporal limit, a geographical limit, a limit on a transaction party, and a limit on a transaction subject.

26. The computer-readable storage medium recited in claim 22 wherein the transaction instruments are selected from the group consisting of a credit card, a debit card, a chip card, a prepaid card, a coupon, and a government-issued coupon.
